(19) United States
(12) Patent Application Publication
(10) Pub. No.: US 2026/0356528 A1
(43) Pub. Date: Nov. 12, 2026

(54) INSTALLATION DEVICE

(71) Applicant: TT Innovation AG, Zug (CH)

(72) Inventors: Simon Daniel Henzmann, Basel (CH); Floiran Simon HUELIN, Windisch (CH); Tobias DE MADDALENA, Kaiseraugst (CH)

(73) Assignee: TT Innovation AG, Zug (CH)

(21) Appl. No.: 18/997,562

(22) PCT Filed: Jul. 13, 2023
(86) PCT No.: PCT/EP2023/069429

§ 371 Date: Jan. 22, 2025

(30) Foreign Application Priority Data
Jul. 22, 2022 (DE) 10 2022 118 418.8

(51) Int. Cl. B65B 43/54; B25J 9/00; B25J 9/16; B65B 3/00; B65B 31/02; B65B 55/02; B65B 59/02; B65G 54/02; F24F 3/163

(52) U.S. Cl. CPC B65B 43/54; B25J 9/0093; B25J 9/1682; B65B 3/003; B65B 31/025; B65B 55/027; B65B 59/02; B65G 54/02; F24F 3/163

(57) ABSTRACT

An an installation device (1) for filled containers (2), having an associated dispensing device (3) for container contents, at least one handling device (5) and at least one transport device (6), which transports the dispensing device (3) and/or the container (2), being formed in a preferably protected working space (4). The transport device (6) has at least one magnetically levitated transport unit (8) coupled to a stator assembly (7).

### CROSS-REFERENCE TO RELATED APPLICATIONS

This application is a 371 National Phase of PCT/EP2023/069429, filed Jul. 13, 2023, which claims priority from German Patent Application No. 10 2022 118 418.8, filed Jul. 22, 2022, both of which are incorporated herein by reference as if fully set forth.

### TECHNICAL FIELD

The invention relates to an installation device for filled containers, having an associated dispensing device for container contents, at least one handling device and at least one transport device, which transports the dispensing device and/or the container, being formed in a preferably protected working space.

### BACKGROUND

Such installation devices are known from protected working spaces in cleanroom technology, which are used in particular in the pharmaceutical industry in the scope of the aseptic production of pharmaceuticals. Depending on the cleanroom class, the working space may be located for example in a RABS (Restricted Access Barrier System), an isolator or an air-controlled and/or microbiologically controlled space. Known installation devices may, however, also be used in working spaces that are not protected.

In the case of installation devices known in practice, in order to transport the dispensing device and/or the container, use is made of transport devices which allow a transport path only in one or two directions. Known transport devices are frequently rail-bound transport devices or conveyor belt systems or rotary-table installation transfer machines. Thus, different handling devices can be approached only one after another, with the result that a total installation process is particularly slow to carry out. A further drawback of such installation devices may be that, in the event of maintenance and/or repairs, process backlogs may occur, which interrupt or at least slow down a process flow.

In known installation devices, the drive area can be in the form of a module of a modular functional area of the working space. This is the case in particular when the functional area consists of insertable modules. Thus, it is possible, for example, for the drive area to be surrounded at least partially by a functional area, for example a grating cover, these two modules being oriented identically on a preferably horizontal level. A drawback here is that, between the grating cover and the drive area, a narrow gap arises, through which dust particles, liquids or other undesired substances can pass. In particular because of the drive area being oriented at the same level as other modules, the risk of contamination may be increased, since, for example, bacteria can pass more easily from one module to the other and thus also to the drive area, this being a drawback in protected working spaces which are used in the aseptic production of pharmaceuticals.

### SUMMARY

Therefore, it is an object of the invention to improve installation devices. In particular, it is an object to improve transport devices of installation devices.

To achieve the abovementioned object, one or more of the disclosed herein are provided according to the invention. Thus, in particular, to achieve the abovementioned object in an installation device of the type mentioned at the beginning, the invention proposes that the transport device has at least one magnetically levitated transport unit coupled to a stator assembly. By way of a magnetically levitated transport unit, the transport of the dispensing device and/or of the container can be carried out without friction and without abrasion, in particular on the drive area described herein. Thus, wearing of the transport unit and of the transport device, and soiling caused for example by abrasion can be reduced, with the result that the durability and/or the operational reliability of the transport device and thus of the installation device can be increased.

As a result of the lower abrasion of the installation device according to the invention that is in operation, it is also possible for a risk of contamination of the dispensing device and/or of the container to be reduced or avoided, and this may be advantageous in particular for work in protected working spaces. Thus, it is possible, in particular, for production standards relevant to the pharmaceutical industry to be complied with.

The stator assembly may comprise an electromagnet such that the transport unit and the transport device can be controlled, in particular switched on and off, as required.

Alternatively or additionally, the stator assembly may comprise a permanent magnet, thereby allowing permanent levitation of the transport unit coupled to the stator assembly. Furthermore, an installation device comprising a permanent magnet may be formed less expensively.

In particular as a result of the abovementioned technical effects and the associated advantages, an installation device can be improved, wherein in particular the transport device can be improved.

In one advantageous configuration, provision may be made for the transport device to be designed to move the at least one transport unit at least in two directions that define an area. As a result, the transport unit can be designed to be movable and can be moved at least in two directions. In this case, the enclosed area may be a polygon, with the result that an area, in particular the drive area described herein, for moving the transport unit can be formed in a particularly variable manner. Since the transport unit is movable in at least two directions that define an area, an interruption to a process flow can be prevented. Thus, it is possible, for example, for a transport unit to bypass a transport unit that needs to be repaired and/or maintained and is thus preferably parked. As a result, a process flow can advantageously be maintained and/or accelerated. Two-dimensional movability of the transport units may be advantageously usable for carrying out complex sequences. In particular, it is thus flexibly possible for a transport unit to be overtaken by another transport unit at virtually any point and/or as required. It is also possible for any desired transport path to be traveled along, such that, for each application and arrangement of the positions to be approached, the optimal route can be chosen.

In particular, provision may be made for a distance of the at least one transport unit from the stator assembly to be controllable. The distance of the at least one transport unit may be varied for example by energizing the stator assembly, in particular when the stator assembly comprises an electromagnet as described above. Thus, the at least one transport unit can, for example, advantageously carry out a vertical movement in order to travel to or dock with a receptacle of a handling device as described herein. Furthermore, tilting and/or rotation of the at least one transport unit may also be provided. As a result of the at least one transport unit being tilted, it is advantageously possible for parts to be installed to be made more easily graspable for a handling device as a result of an inclined position. Rotation allows the at least one transport unit to be rotated about its own axis, for example for preferably all-round inspection or orientation of a transported article, in particular the containers and/or dispensing device mentioned herein, by an inspection device as described herein. An advantage in particular in this configuration may be that the transport unit can be movable in up to six degrees of freedom.

Generally, a protected space can be characterized for example in that it allows controlled exchange with an environment. This may be achievable for example in that undesired substances are impeded or even prevented from escaping from the protected space and/or entering the protected space.

In an advantageous configuration, provision may be made for the protected working space to have vents and/or a ventilation system. In this way, a laminar flow or low-turbulence flow can be formed, this being particularly advantageous in the production of aseptic pharmaceuticals, pharmaceutical devices, medical products and/or medical devices. Furthermore, as a result of vents and/or as a result of the ventilation system, a defined cleanroom air quality can be established, and this can be particularly advantageous in isolators or RABS. In a likewise advantageous configuration, in which air inlet openings are provided, the working space can be operated with a turbulent mixed air flow.

Alternatively or additionally, the protected working space can also have filter systems known to a person skilled in the art, in particular for isolators and/or RABS.

In an advantageous configuration, provision may be made for the transport device to have a drive area which is delimited by a change in level, in particular a reduction in level. The drive area may at least partially comprise the stator assembly described herein. As a result, the at least one transport unit can, in a magnetically levitatable manner, be moved to and positioned at a different level compared to a different device, for example a handling device as described herein. In this way it is possible to prevent contaminants such as bacteria and/or suspended particles passing onto the drive area and thus contaminating the transport unit and/or the dispensing device and/or the container.

The change in level may, for example, be advantageously used to create controlled flow conditions at the drive area in the presence of an air flow. Here, a reduction in level is particularly advantageous when a ventilation system is used, the main direction of flow of which coincides with a direction of the reduction in level.

A drive area which is delimited by a reduction in level may be particularly advantageous. A reduction in level may be defined in particular in that a laminar flow and/or low-turbulence air flow and/or a turbulent mixed air flow at the drive area can be guided into a gulf. Alternatively or additionally, the gulf formed by the reduction in level may in particular have an extent greater than half a width of the transport unit. In particular, provision may be made for the gulf formed by the reduction in level to be deep enough that if, adjoining the drive area, a bottom of the gulf were to be designed to be magnetizable by a stator assembly, the transport unit traveling over the drive area could not be coupled to the magnetized bottom. In that case, the transport unit would irreversibly fall down the gulf. As a result of a reduction in level, the transport unit can particularly advantageously be positioned at a higher level than an anchoring point of the at least one handling device described herein. In this way, a drive area can be free of devices, for example handling devices, which in particular are not transport units. As a result, transport units can be designed to be movable in many directions on a relatively small drive area. In this way, the installation device can carry out many (partial) processes at the same time, with the result that a total process time can be reduced. In this way, an installation device can be improved overall.

Furthermore, as a result of the reduction in level, a low-turbulence flow can be achieved at the level of the drive area, since, for example, as already mentioned, handling devices can be anchored outside the drive area and thus do not form an obstacle to flow. This is the case in particular when a laminar flow and/or a low-turbulence flow flows out of a ventilation system as described herein in the direction of the drive area. This is particularly advantageous when working in protected working spaces.

In an advantageous configuration, provision may be made for the change in level, in particular the reduction in level, to partially delimit the drive area. Thus, the drive area is delimited by a change in level in particular portions, i.e. not all around, in particular at a boundary edge as described herein. For example, the drive area can be partially delimited by structures which are used advantageously for active or passive air extraction. These structures may in particular comprise the vents described herein.

Furthermore, partial delimitation of the drive area allows variable positioning of, for example, handling devices, as are described herein. Thus, it is possible, for example, for handling devices to be positioned at different levels than one another and/or than the drive area. As a result, the protected working space can be exploited optimally.

In an advantageous configuration, provision may be made for an air flow in the protected working space to be discharged via the change in level, in particular via the reduction in level. Thus, the air flow can advantageously be discharged outside the drive area and/or installation regions.

Air flow is understood here to be mean in particular the laminar flow and/or low-turbulence flow and/or mixed air flow described herein.

In particular, in this case, the air flow can be discharged via the vents described herein. In this case, the vents can be included in a grating structure at least partially delimiting the drive area. Via the vents, the air flow can be effectively discharged.

Alternatively or additionally, the air flow can pass to a lower level of the change in level, in particular the reduction in level. In this way, the air flow can be discharged at a distance from the drive area, handling devices and/or transport units. It may be advantageous that, in the event of turbulence of the discharged air, this air does not pass back from the lower level to the drive area. In this way, an air flow can be maintained in the protected working space, such that, in particular, the risk of contamination can be reduced.

In an advantageous configuration, provision may be made for at least one transport unit to be able to move around on the drive area, and for the at least one handling device to be positioned next to the drive area on a lowered level with respect to the drive area. In this way, it is possible, as mentioned above, for a flow through the working space, in particular the drive area to exhibit lower turbulence, since the at least one handling device, in this configuration, forms a small or no obstacle to flow at least in the region of the drive area. This is advantageous in particular when the installation device forms a plurality of handling devices in order to carry out complex installations and/or to carry out installations particularly quickly.

In an advantageous configuration, provision may be made for at least one material repository to be arranged on the lowered level. In this way, a feed or discharge of a material, for example the dispensing device described herein and/or parts thereof, can be mounted outside the working area, such that the material repository also does not disturb a laminar flow and/or a low-turbulence flow and/or a mixed air flow.

Alternatively or additionally, provision may be made for a tile to be replaced by a handling device and/or inspection device, with the result that these devices can be approached by the at least one transport unit from different sides.

Alternatively or additionally, provision may be made for at least one inspection device, in particular an inspection camera and/or an inspection feeler, and/or at least one inscription device to be set up. Thus, an installed container and/or a container to be installed and/or a transport unit can advantageously be inspected, with the result that process monitoring can be ensured. Furthermore, in particular a filled container can be labeled by an inscription device, and this may be useful for storage and/or for identification.

In an advantageous configuration, provision may be made for the or a material repository to be configured such that at least two containers of the same type can be stored therein, in particular without disrupting the integrity of the protected working space. As a result, at least two containers of the same type can be stored in the material repository. In this way, installations of multiple containers can be carried out in a short time, with the result that an installation device can produce a particularly high product number per unit time. This may in particular also be possible since the integrity of the working space is not disrupted, since no installation-interrupting processes are carried out. It is also possible for the material repository to be configured and able to be equipped such that so many containers are deposited therein that hardly any or no idle times arise between installations of individual containers.

In an advantageous configuration, provision may be made for the drive area to be formed by tiles of identical size. In this way, a drive area can be formed in a structurally simple manner, since, for example, a boundary edge can be adapted more easily to a handling device described herein, in particular when provision is made for a handling device to be set up at each boundary edge of the drive area. In this way, the entire drive area can be used as a transport path for the material flow. As a result, the preferably protected space can be exploited optimally. Thus, it is advantageously possible for an installation device to be formed in space-saving manner.

Provision may be made for the drive area to have a rectangular basic shape, with the result that the handling devices can be positioned better with respect to one another. This may be helpful, for example, when handling devices, as described herein, are designed to carry out a handshake, preferably outside the transport device, independently of the transport device.

Alternatively, provision may be made for a handling device to be positioned at at least one, in particular at at least two, boundary edge(s). In this way, it is possible, in particular when the drive area does not have a rectangular basic shape, for at least one boundary edge to be free of handling devices. This at least one free boundary edge may be used for the further configuration of and/or for saving space in the preferably protected working space.

As described above, the drive area may have a polygonal basic shape, with the result that a transport path or a material flow can be adapted to structural embodiments of the installation device, for example the number and/or the configuration of handling devices. As a result, the installation device can advantageously be formed in a customized manner.

In an advantageous configuration, provision may be made for the drive area to be formed by tiles of different sizes. In this way, the shape of the drive area can be adapted better to the space conditions in particular in the protected working space. Thus, it is possible, for example, for the drive area to be formed with an L-, E- or T-shaped basic shape.

In an advantageous configuration, provision may be made for at least two handling devices to be formed, which are connected together by the transport device in a material flow, wherein the installation device is furthermore characterized in that the at least two handling devices are designed to carry out a handshake independently of the transport device. As a result of at least two handling devices, more complex installations of, for example, dispensing devices and/or containers and/or other medical products or medical devices can be carried out, with the result that an installation device can produce a multiplicity of dispensing devices and/or containers and/or other medical products or medical devices, with the result that, advantageously, the installation device can be used in particular for the installation of containers of different types. Furthermore, multiple dispensing devices and/or containers and/or other medical products or medical devices can be installed per unit time by more than one handling device, this particularly improving an installation device. As a result of a handshake of two handling devices, components can be transferred from one handling device to a second, with the result that the installation time for multiple dispensing devices and/or containers and/or other medical products or medical devices can be particularly quick. A handshake also allows the separate manipulation of second parts of the transferred product, for example relative adjustment of the parts with respect to one another.

For example, a first handling device can pick up a second dispensing device from the abovementioned material repository, while, preferably at the same time, a second handling device installs a first dispensing device with the container. Then, a handshake of the first and second handling devices can be carried out, wherein the second dispensing device is transferred to the second handling device. Subsequently, the second handling device can install the second dispensing device with a further container, while the first handling device picks up a third dispensing device.

Preferably, the two handling devices are designed to carry out a handshake outside the transport device. It may be advantageous in this embodiment for a transfer, as described above, to take place outside the transport device, with the result that transport paths are not impeded. Furthermore, in the case of a faulty transfer, wherein a transferred object is dropped, it is possible for the transport device to be protected from damage.

In an advantageous configuration, provision may be made for the at least one handling device to have at least two, preferably at least three movement axes. In this way, the at least one handling device can carry out particularly variable movements, and this may be particularly advantageous when the at least one handling device is designed to carry out a handshake as described herein.

In an advantageous configuration, provision may be made, in the case of the installation device, for at least two handling devices to be formed, which are connected together by the transport device in a material flow, wherein the installation device is furthermore characterized in that the transport device provides a direct transport path between each handling device and all other handling devices. A material flow can, for example, connect the handling devices together when, as described herein, a handling device is positioned at each boundary edge of the drive area. In this way, it is advantageously possible for each handling device to contribute to the installation of filled containers, with the result that a total process can be particularly quick.

A direct transport path between each handling device and between all handling devices allows a flexible movement of the at least one transport unit between the individual handling devices. For example, a transport unit may bypass one or more handling devices and head for any other desired handling device. As a result, an installation device can be particularly improved since installations are able to be carried out very quickly and are less susceptible to damage (for example at a handling device). It is also possible for multiple handling devices to be installed, wherein some of the handling devices are not required for particular installation processes. Thus, it is possible to switch between different installation processes with little or even without additional effort. In this way, an installation device can advantageously be used to install multiple different dispensing devices and/or containers and/or other medical products or medical devices.

Direct transport paths are particularly advantageous when multiple transport units are moved around simultaneously on the drive area. As a result, one transport unit can head for handling devices independently of another transport unit. In this way, by way of the installation device, installations of multiple containers can be carried out close in time to one another or simultaneously, in particular when the handling devices are designed to carry out handshakes. Such an installation device is particularly improved.

In an advantageous configuration, provision may be made for the direct transport path to extend along a shortest connecting line between the respectively connected handling devices. In this way, a transport unit can travel along the shortest connecting line in order to pass from one handling device to another handling device, in particular when the drive area has a rectangular basic shape. As a result, a material flow and/or an installation of containers can be carried out particularly efficiently.

Handling devices may, in particular, be: robots, presses, installation actuators, sensors, scales, portals, processing devices, etc.

In an advantageous configuration, provision may be made for the transport device to have tiles with coils. The tiles can form the stator assembly described herein. Thus, the magnetic coupling of the at least one transport unit can be carried out by, in particular, each tile. This advantageously makes it possible and how, in particular, provision may be made for at least one internal tile to define a park position.

Alternatively or additionally, the at least one internal tile can define a direct connection between two handling devices that are not directly adjacent. By way of the at least one internal tile, the direct transport path can advantageously extend along the above-described shortest connecting line between two handling devices.

Provision may in particular be made for external tiles to define a peripheral transport path. In this way, a material flow can be maintained even when a transport unit is parked at a park position as described herein. In the case of a peripheral transport path, it may also be advantageous for the transport device or the material flow to be able to extend close to the handling device. In this way, the handling devices do not need to project far into the region of the drive area, with the result that a through-flow through the preferably protected working space can be kept low-turbulence.

In an advantageous configuration, provision may be made for the transport device to be designed to move the at least one transport unit along a preferably freely configurable transport path in both senses of direction. In this way, the at least one transport unit can be moved forward and backward, this being particularly advantageous. A transport unit that is able to be moved forward and backward allows even greater flexibility in the material flow.

In an advantageous configuration, provision may be made for the at least one transport unit to be able to be equipped with a molded part adapted to the shape of the dispensing device and/or the container. As a result of the shape-adapted part, installation of the container with the dispensing device can be carried out optimally, since a higher processing force can be applied during installation by the installation device. In this way, the product quality can advantageously be increased.

In particular, provision may be made for the molded part to be able to be equipped from a store positioned next to the transport device. In this way, the molded part can be assembled with the transport unit in the working space, and this may be time-saving. It may also be advantageous for a transport unit to be equipped with a shape-adapted molded part depending on the container to be installed, with the result that an installation device can install containers of different types.

The transport unit may advantageously be equipped with a shape-adapted molded part by at least one handling device. In this way, the integrity of the protected working space can be maintained, with the result that installation processes of containers do not need to be interrupted. It is also not necessary for installation processes of containers to be interrupted in particular when the handling device that has been parked for equipping the transport unit is bypassed by other transport units. This may be the case in particular when, as described herein, the transport device provides a direct transport path between each handling device and all other handling devices.

In an advantageous configuration, provision may be made for the at least one handling device to be able to carry out at least one installation step outside a movement corridor of the at least one transport unit. The movement corridor may be defined in particular as an extension, oriented transversely to the drive area, of the transport unit, transporting and/or not transporting a dispensing device and/or the container. In this way, the at least one handling device can carry out at least one installation step independently of transport units moving on the drive area.

### BRIEF DESCRIPTION OF THE DRAWINGS

The invention will now be described in more detail with reference to exemplary embodiments, but is not limited to these exemplary embodiments. Further exemplary embodiments will result from combining the features of individual or multiple claims with one another and/or with individual or multiple features of the exemplary embodiments.

In the figures:

FIG. 1 shows an installation device according to the invention with a handling device and a dispensing device in a protected working space,

FIG. 2 shows an alternative installation device according to the invention with two handling devices,

FIG. 3 shows a top view of a third embodiment according to the invention of an installation device,

FIG. 4 shows a top view of a fourth embodiment according to the invention of an installation device,

FIG. 5 shows a top view of a fifth embodiment according to the invention of an installation device, wherein a handling device is surrounded by the drive area,

FIG. 6 shows a top view of a sixth embodiment according to the invention of an installation device, wherein the reduction in level partially delimits the drive area,

FIGS. 7 and 8 show installation devices according to the invention, the drive areas of which do not have a rectangular basic shape.

### DETAILED DESCRIPTION

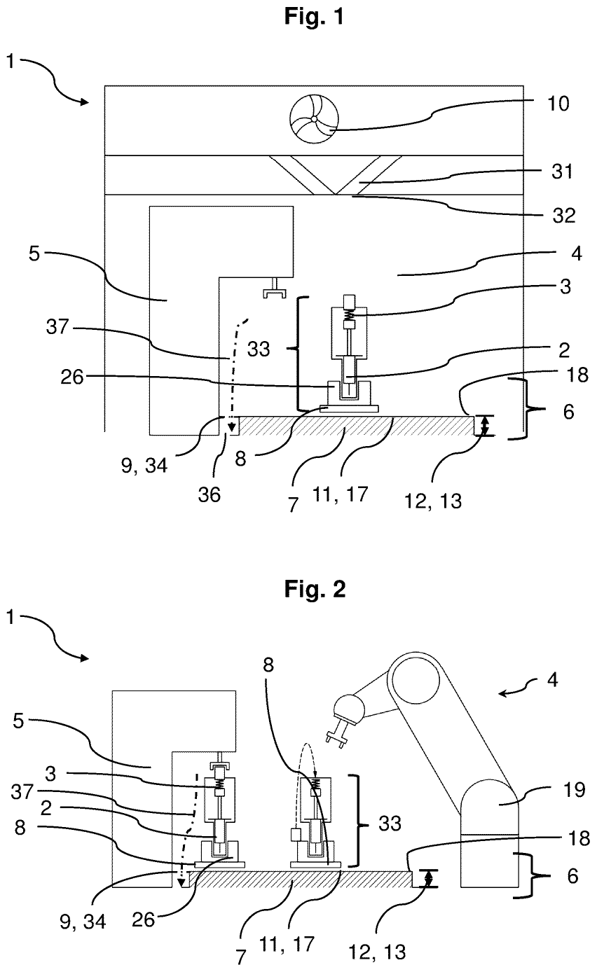

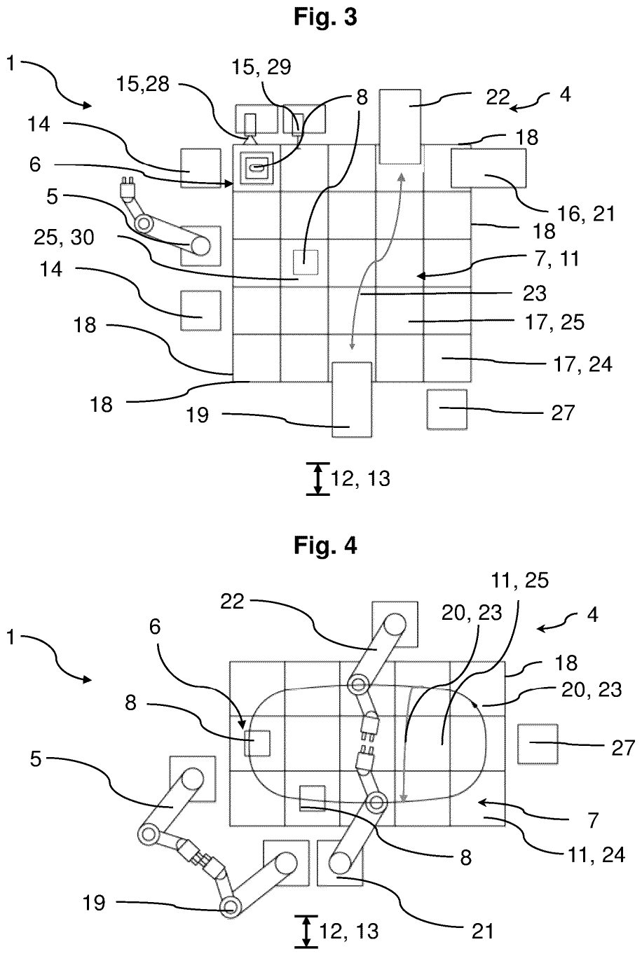

FIGS. 1 to 8 show alternative embodiments of an installation device 1 according to the invention for filled containers 2 having an associated dispensing device 3 with container contents, wherein the containers 2 are highlighted only in FIGS. 1, 2 and 6 for clearer illustration. FIGS. 1 to 8 also show a protected working space 4, in which one (FIG. 1), two (FIGS. 2/6/7) or four (FIGS. 3/4/5/8) handling devices 5 are formed. The protected working space 4 is a RABS in the embodiments shown here, but may also be in the form of an isolator or of a space with a turbulent mixed air flow. As illustrated in FIGS. 1 and 6, the protected working space 4 has, to form a laminar flow and/or a low-turbulence air flow 37, vents 9, a ventilation system 10 with a filter 31 and air inlet openings 32. The protected working spaces 4 of the embodiments of an installation device 1 that are shown in the other figures are also formed in a similar manner.

In embodiments of the installation devices 1 shown in FIGS. 1 to 8 that are not shown, the working space 4 is not a protected working space 4. The installation device 1 is thus suitable for a wide variety of processes in very different industrial sectors.

The installation devices 1 of the embodiments that are shown form at least one transport device 6 transporting the dispensing device 3 and the container 2. The transport units 8 of the transport devices 6 are coupled to a stator assembly 7 and magnetically levitated. As a result, the transport of the dispensing device 3 and/or of the containers 2 is frictionless, and so the installation device 1, in particular the transport device 6, is durable. Furthermore, as a result of reduced abrasion, the transport device 6, in particular the drive area 11, can be cleaned more easily and at greater intervals.

The transport unit 8 is equipped with a molded part 26 with a shape adapted to the dispensing device 3 and/or the container 2 (see FIGS. 1, 2 and 6), such that the installation of the dispensing device 3 on at least one of the handling devices 5, 19, 21, 22 shown in the figures is carried out under the optimal effect of a processing force exerted by the handling devices 5, 19, 21, 22. The transport units 8 shown are able to be equipped with different shape-adapted molded parts 26, such that the installation device 1 can process containers 2 of different types, this being particularly customer-friendly since installations of different containers 2 can be executed in an installation device 1. The transport units 8 are equipped with the shape-adapted molded parts 26 from a store 27 positioned next to the transport device 6 and with one of the handling devices 5, 19, 21, 22 (see FIGS. 3 and 4).

The installation devices 1 shown in the embodiments are characterized in that the transport devices 6 are designed to move the transport units 8 at least in two directions that define an area. In this way, it is possible for the transport units 8 to travel in more than one direction and so a backlog of the transport units 8 can be prevented, such that an installation process as a whole is scarcely or not impeded. Furthermore, the transport devices 6 are designed such that a distance between the transport units 8 and the stator assemblies 7 can be controlled. Preferably, the distance is controllable by an electromagnet located in the stator assembly 7. In general, the transport units 8 can be moved in up to six degrees of freedom, such that the transport units can carry out, for example, tilting and/or rotating movements.

The drive areas 11 of the transport devices 6 in FIGS. 1 to 8 are delimited by a change in level 12, in this case a reduction in level 13. The reduction in level 13 may delimit the drive area 11 partially, as shown in FIGS. 1, 2 and 6, or entirely, as can be seen in the other figures. Partial delimiting of the drive area 11 can be realized by a grating structure 34 having vents 9 and/or by at least one of the handling devices 5, 19, 21, 22, which are attached directly to the drive area 11, preferably with a form fit. In this way, in the protected working space 4, the laminar flow or low-turbulence flow can be formed in a particularly stable and optimal manner, in particular in the region of the handling devices 5, 19, 21, 22 and of the containers 2. As a result of the change in level 12, 13, complicated constructions, for example of the handling devices 5, 19, 21, 22, can be prevented.

In the installation device 1 shown in FIG. 6, the reduction in level 12, 13 is formed such that the handling devices 5, 19 are formed above the bottom 35 of the installation device 1. Furthermore, it is apparent from this figure (and from FIG. 1/2) that an air flow 37 in the protected working space 4 is discharged via the reduction in level 12, 13 and is discharged via the vents 9. In this way, the air flow 37 in the protected working space 4 can be discharged particularly readily. In particular, the air flow 37 can be discharged away from the drive area 11, in particular to the lower level 36 of the reduction in level 12, 13.

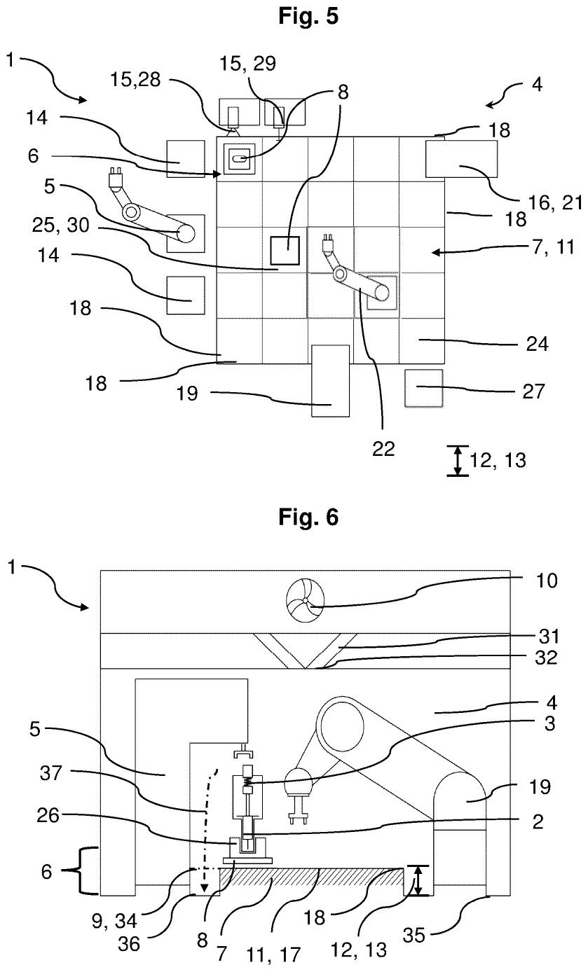

The transport units 8 that are able to be moved around on the drive area 11 approach the handling devices 5, 19, 21, 22, which are positioned next to the drive area 11 on a level 12, 13 that is lowered with respect to the drive area 11 (see FIG. 3). In addition to the handling devices 5, 19, 21, 22, a material repository 14 is arranged on the lowered level 12, 13, on which repository, for example, the containers 2 and/or dispensing devices 3 are deposited or able to be deposited. The material repository 14 is designed such that at least two containers 2 of the same type can be stored therein, in particular without disrupting the integrity of the protected working space 4. Thus, many containers 2 can be installed per unit time. Furthermore, two inspection devices 15, namely an inspection camera 28 and an inspection feeler 29, for inspecting the transport units 8 and/or the containers 2 to be installed, are arranged on the lowered level 12, 13. An inscription device 16 for labeling the containers 2 is positioned in a similar manner. In FIG. 5, the handling device 22 is surrounded by the drive area 11, with the result that a particularly large amount of space can be saved, with, at the same time, increased flexibility of the installation device 1.

As is illustrated in particular in FIGS. 3 and 4, the drive area 11 is characterized by a rectangular basic shape. In this case, a handling device 5, 19, 21, 22 is positioned at each boundary edge 18 of the drive area 11 (see FIG. 3). In this way, the drive area 11 is approached by at least one transport unit 8 at each boundary edge 18 and is functionally used by one of the handling devices 5, 19, 21, 22. Thus, the installation device 1 has scarcely any or no unused working space 4 and is thus formed in a space-saving manner.

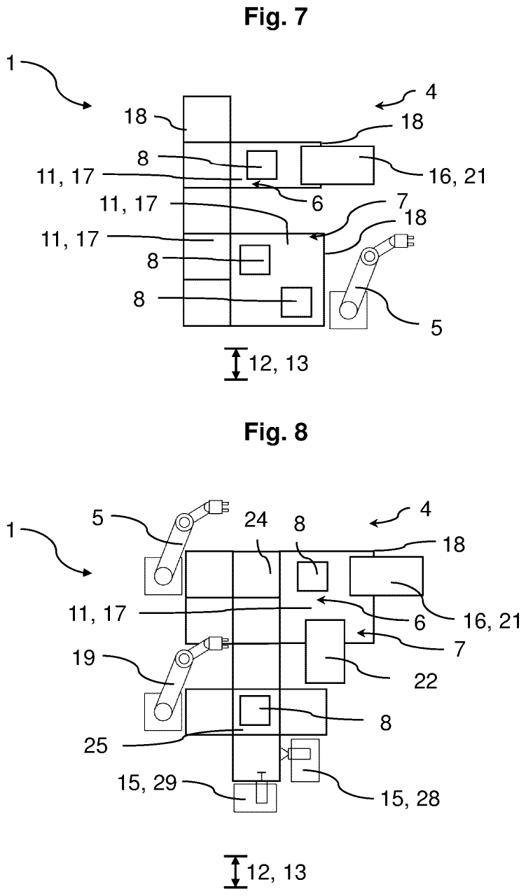

FIGS. 7 and 8 show installation devices 1 which do not have a rectangular drive area 11. For example, the drive area 11 of the installation device shown in FIG. 7 differs from the rectangular basic shape by the use of tiles 17 with different sizes. Located on the medium-sized tiles 17 is an inscription device 16, 21. Located on the large tiles 17 is a handling device 5 and a plurality of transport units 8. The inscription device 16, 21 and the handling device 5 are each positioned at a boundary edge 11, such that, for example, the long boundary edge 18 formed by five tiles 17 of the same size remains free. By way of the installation devices 1 shown in FIGS. 7 and 8, the respective working spaces 4 are adapted optimally to the customer's wishes.

The tiles 17 of the drive areas 11 in FIGS. 1 to 6 are the same size, in order to form the rectangular basic shape, and have coils. In this case, the tiles 17 are arranged such that external tiles 24 define a peripheral transport path 23. The internal tiles 25 form, for example, a park position 30 in which transport units 8 can be parked in particular when not in use, without blocking the transport path 23 and/or the material flow 20. In this case, internal tiles 25, on which transport units 8 are parked, can be arranged in the drive area 11 such that further internal tiles 25 still define a direct connection between two handling devices 5, 19, 21, 22 that are not directly adjacent, as can be seen in the embodiment according to FIG. 3. In this way, for example, the direct path 23 on the shortest connecting line between the handling devices 19 and 22 is not disrupted.

As a result of the tiles 17, 24, 25 and the stator assembly 7 and the polygonal, in particular rectangular basic shape of the drive area 11, the transport device 6 is designed to move the transport units 8 along the transport path 23 in both senses of direction (cf. FIG. 4). In this case, the transport path 23 of one or more transport units 8 can form a large and/or small circle, as is illustrated in FIG. 4. In particular, the transport path 23 may be able to be freely configured to be adaptable to a traffic and/or process situation. In this way, blocking or delaying of installations can be prevented. Furthermore, multiple installations can take place at the same time and in parallel, and so very many installations can be carried out per unit time.

As is shown in particular in FIGS. 3, 4 and 5, the installation devices 1 illustrated therein have a plurality of handling devices 5, 19, 21, 22 which are connected together by the transport device 6 in a material flow 20 (see in particular FIG. 4). In this case, the handling devices 5, 19, 21, 22, for example the handling devices 5 and 19 in FIG. 4, are designed to execute a handshake independently of the transport device 6 and outside the transport device 6. In this way, at least one installation step can be carried out by the installation device 1 outside the drive area 11 or the transport device 6, such that the transport device 6 can be protected. This is realized in particular in that the handling devices 5, 19, 21, 22 execute at least one installation step outside a movement corridor 33 of the at least one transport unit 8. The movement corridor 33 of the transport unit 8 is the extension, oriented transversely to the drive area 11, of the transport unit 8, with a dispensing device 3 and container 2 (see FIGS. 1 and 2). Furthermore it is possible, as a result, for the transport device 6 to move more transport units 8, with simultaneous installation of containers 2, such that a total process time is accelerated.

The handling devices 5, 19, 21, 22 each have at least three movement axes, such that the handling devices 5, 19, 21, 22 can carry out multiple processes flexibly. For example, the handling devices 5, 19, 21, 22 can move such that the handling devices 5, 19, 21, 22 can grasp containers 2 from the material repository 14, carry out the abovementioned handshake, and can transfer the containers 2 to transport units 8.

The invention thus proposes in particular an installation device 1 for filled containers 2, having an associated dispensing device 3 for container contents, wherein at least one handling device 5 and at least one transport device 6, which transports the dispensing device 3 and/or the container 2, is formed in a preferably protected working space 4, wherein the transport device 6 has at least one magnetically levitated transport unit 8 coupled to a stator assembly 7.

### LIST OF REFERENCE SIGNS

1 Installation device
2 Filled container
3 Dispensing device
4 Working space
5 Handling device
6 Transport device
7 Stator assembly
8 Transport unit
9 Vent
10 Ventilation system
11 Drive area
12 Change in level
13 Reduction in level
14 Material repository
15 Inspection device
16 Inscription device
17 Tiles of 11
18 Boundary edge of 11
19 Handling device
20 Material flow
21 Handling device
22 Handling device
23 Transport path
24 External tile
25 Internal tile
26 Molded part of 8
27 Store
28 Inspection camera
29 Inspection feeler
30 Park position
31 Filter
32 Air inlet openings
33 Movement corridor of 8
34 Grating structure
35 Bottom of 1
36 Lower level of 12, 13
37 Air flow

1. An installation device (1) for filled containers (2), having an associated dispensing device (3) for container contents, in pharmaceutical processing, the installation device (1) comprising:
at least one handling device (5);
at least one transport device (6), which transports at least one of the dispensing device (3) or the container (2); and
the transport device (6) has at least one magnetically levitated transport unit (8) coupled to a stator assembly (7).

2. The installation device (1) as claimed in claim 1, wherein the transport device (6) is designed to move the at least one transport unit (8) at least in two directions that define an area.

3. The installation device (1) as claimed in claim 1, wherein the at least one transport device (6) transports the at least one of the dispensing device (3) or the container (2) in a protected working space (4), and the protected working space (4) has at least one of vents (9) or a ventilation system (10).

4. The installation device (1) according to claim 3, wherein
the transport device (6) has a drive area (11) which is delimited by a change in level (12),
an air flow (37) in the protected working space (4) being discharged via the change in level (12),
the at least one transport unit (8) being able to move around on the drive area (11), and
the at least one handling device (5) is positioned next to the drive area (11) on a lowered level with respect to the drive area (11).

5. The installation device (1) as claimed in claim 4, wherein the change in level (12) partially delimits the drive area (11).

6. The installation device (1) as claimed in claim 5, wherein the air flow (37) in the protected working space (4) is discharged via the change in level (12), via the at least one of the vents (9) or the air flow (37) passing to a lower level (36) of the change in level (12).

7. The installation device (1) as claimed in claim 4, further comprising at least one of at least one material repository (14) arranged on the lowered or at least one inspection device (15) set up on the lowered level.

8. The installation device (1) as claimed in claim 4, further comprising a material repository (14) configured such that at least two containers (2) of a same type are adapted to be stored therein without disrupting an integrity of the protected working space (4).

9. The installation device (1) as claimed in claim 4, wherein the drive area (11) is formed by tiles (17) of identical size, with the at least one handling device (5) being positioned at each boundary edge (18) of the drive area (11), or wherein the at least one handling device (5) is positioned at at least one boundary edge(s) (18).

10. The installation device (1) as claimed in claim 9, wherein the tiles that form the drive area (11) have different sizes.

11. The installation device (1) according to claim 1, wherein the at least one handling device comprises at least two of the handling devices (5, 19, 21, 22), which are connected together by the transport unit (8) in a material flow (20), wherein the at least two of the handling devices (5, 19, 21, 22) are designed to carry out a handshake independently of the transport device (6).

12. The installation device (1) as claimed in claim 1, wherein the at least one handling device (5, 19) has at least two movement axes.

13. The installation device (1) according to claim 1, wherein the at least one handling device comprises, at least two handling devices (5, 19, 21, 22), which are connected together by the transport device (6) in a material flow (20), the transport device (6) providing a direct transport path between each of the handling device (5, 19, 21, 22) and all other handling devices (5, 19, 21, 22), the transport device (6) having tiles (17) with coils, wherein external ones of the tiles (24) defining a peripheral transport path (23), and at least one internal tile (25) defining at least one of a park position (30) or a direct connection between two handling devices (5, 19, 21, 22) that are not directly adjacent.

14. The installation device (1) as claimed in claim 13, wherein the direct transport path (23) extends along a shortest connecting line between respectively connected ones of the handling devices (5, 19, 21,22).

15. The installation device (1) as claimed in claim 1, wherein the transport device (6) is configured to move the at least one transport unit (8) along a configurable transport path (23) in both directions.

16. The installation device (1) as claimed in claim 1, wherein the at least one transport unit (8) is able to be equipped with a molded part (26) adapted to a shape of the at least one of the dispensing device (3) or the container (2).

17. The installation device (1) as claimed in claim 1, wherein the at least one handling device (5, 19, 21, 22) is able to carry out at least one installation step outside a movement corridor (33) of the at least one transport unit (8).

18. (canceled)

19. (canceled)

20. An installation device (1) for filled containers (2), having an associated dispensing device (3) for container contents, in pharmaceutical processing, the installation device (1) comprising:
at least one handling device (5);
at least one transport device (6), which transports at least one of the dispensing device (3) or the container (2);
the transport device (6) has a drive area (11) which is delimited by a change in level (12);
an air flow (37) in the protected working space (4) being discharged via the change in level (12);
the at least one transport unit (8) being able to move around on the drive area (11); and
the at least one handling device (5) is positioned next to the drive area (11) on a lowered level with respect to the drive area (11).

21. An installation device (1) for filled containers (2), having an associated dispensing device (3) for container contents, in pharmaceutical processing, the installation device (1) comprising:
at least two handling devices (5);
at least one transport device (6), which transports at least one of the dispensing device (3) or the container (2);
the transport device (6) has a drive area (11) which is delimited by a change in level (12);
an air flow (37) in the protected working space (4) being discharged via the change in level (12);
the at least one transport unit (8) being able to move around on the drive area (11); and
the at least two of the handling devices (5, 19, 21, 22) are connected together by the transport unit (8) in a material flow (20), wherein the at least two of the handling devices (5, 19, 21, 22) are designed to carry out a handshake independently of the transport device (6).
